(19) United States
(12) Patent Application Publication
(10) Pub. No.: US 2023/0193084 A1
(43) Pub. Date: Jun. 22, 2023

(54) ADHESIVE TAPE AND ELECTROCHEMICAL APPARATUS INCLUDING SUCH ADHESIVE TAPE

(71) Applicant: Ningde Amperex Technology Limited, Ningde (CN)

(72) Inventor: Xiao CHEN, Ningde (CN)

(73) Assignee: Ningde Amperex Technology Limited, Ningde (CN)

(21) Appl. No.: 18/067,315

(22) Filed: Dec. 16, 2022

(30) Foreign Application Priority Data
Dec. 17, 2021 (CN) 202111551402.7

(51) Int. Cl. C09J 7/29

(52) U.S. Cl. CPC C09J 7/29; C09J 2203/33; C09J 2301/416; C09J 2433/006; C09J 2467/006; C09J 2423/106; C09J 2423/046; C09J 2433/00; C09J 2423/00; C09J 2421/00

(57) ABSTRACT

An adhesive tape includes a composite membrane and an adhesive layer, where the composite membrane includes a substrate and a hardening layer provided on a surface of the substrate, and a hardness of the hardening layer is 3H to 9H. The adhesive tape provided in this application has both small thickness and high hardness, which increases volumetric energy density of the electrochemical apparatus and can further effectively avoid tape wrinkling of the electrochemical apparatus.

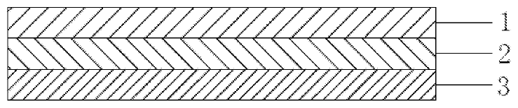

### CROSS-REFERENCE TO RELATED APPLICATIONS

This application claims the benefit of priority of Chinese patent application 202111551402.7, filed on Dec. 17, 2021, the contents of which are incorporated herein by reference in its entirety.

### TECHNICAL FIELD

This application relates to the field of energy storage technologies, and in particular, to an adhesive tape and an electrochemical apparatus including such adhesive tape.

### BACKGROUND

Adhesive tapes are widely applied to lithium-ion batteries and mainly used for fastening, insulating, and protecting battery cells, tabs, and stop parts in the lithium-ion batteries, bundling and fastening battery modules, and manufacturing advanced finished batteries. Structures of most existing adhesive tapes each include an adhesive layer applied on one or two sides of the substrate of the adhesive tapes. In the prior art, with increasingly high requirements for energy density of the lithium-ion batteries, the adhesive tapes are designed to be increasingly thin, and as a result, the adhesive tapes are more prone to wrinkling. Therefore, there is an urgent need for an adhesive tape to be used in the lithium batteries, satisfying that the adhesive tape is thin enough and not prone to wrinkling.

### SUMMARY

In view of technical disadvantages in the prior art, this application provides an adhesive tape, where the adhesive tape is thin enough and also has enough hardness, so that the adhesive tape is not prone to wrinkling, thereby allowing volumetric energy density of electrochemical apparatuses to be constantly increased. This application further relates to an electrochemical apparatus including such adhesive tape and an electronic apparatus.

According to a first aspect, this application provides an adhesive tape, including a composite membrane and an adhesive layer, where the composite membrane includes a substrate and a hardening layer provided on a surface of the substrate, and a hardness of the hardening layer is 3H to 9H. According to some embodiments of this application, the hardness of the hardening layer is 3H, 4H, 5H, 6H, 7H, 8H, or 9H.

According to some embodiments of this application, a thickness of the hardening layer is 0.5 μm to 5 μm. According to some embodiments of this application, the thickness of the hardening layer is 0.5 μm, 1 μm, 2 μm, 2.5 μm, 3 μm, 3.5 μm, 4 μm, 4.5 μm, 5 μm, or any value therebetween.

According to some embodiments of this application, a thickness of the substrate is 2 μm to 8 μm. According to some embodiments of this application, the thickness of the substrate is 2 μm, 3 μm, 4 μm, 5 μm, 6 μm, 7 μm, 8 μm, or any value therebetween.

In the adhesive tape of this application, the composite membrane being provided with the hardening layer on the substrate increases hardness of the composite membrane, so that the adhesive tape has both small thickness and high hardness, thereby allowing volumetric energy density of electrochemical apparatuses to be constantly increased and effectively avoiding wrinkling of the adhesive tape in the electrochemical apparatus.

According to some embodiments of this application, a dissolution rate of the composite membrane in an electrolyte solvent is 0.2% to 6%. According to some embodiments of this application, the dissolution rate of the composite membrane in the electrolyte solvent is 0.2%, 0.5%, 1%, 1.5%, 2%, 2.5%, 3%, 3.5%, 4%, 4.5%, 5%, 5.5%, 6%, or any value therebetween. In this application, the dissolution rate of the composite membrane in the electrolyte solvent is a weight change rate of the composite membrane after being subjected to soaking in the electrolyte solvent, pre-drying, and re-drying, and can be obtained based on a formula: dissolution rate=(weight before soaking−weight after drying)/weight before soaking×100%. Soaking temperature is 80° C. and soaking duration is 6 days. Pre-drying duration is 4 days and pre-drying temperature is 60° C. Re-drying temperature is 115° C. and re-drying duration is 2 days. The electrolyte solvent includes ethylene carbonate (EC), propylene carbonate (PC), diethyl carbonate (DEC), and ethyl propionate (EP). In some specific embodiments, the electrolyte solvent for testing the dissolution rate is ethylene carbonate (EC), propylene carbonate (PC), diethyl carbonate (DEC), and ethyl propionate (EP), where a mass ratio of EC:PC:DEC:EP is equal to 3:1:3:3.

According to some embodiments of this application, the hardening layer is formed by curing a hardening solution.

According to some embodiments of this application, the hardening solution includes a polyacrylate prepolymer, and the polyacrylate prepolymer includes 3 to 9 alkene functional groups. As the number of alkene functional groups increases, a polymerization degree and hardness of the polyacrylate prepolymer are also increased, reducing the dissolution rate in electrolyte of the electrochemical apparatus.

According to some embodiments of this application, the polyacrylate prepolymer further includes one or more of a benzene ring, heterocycle, or bridged-ring functional group.

According to some embodiments of this application, the polyacrylate prepolymer includes at least one of di(trimethylolpropane) tetraacrylate, ethoxylated trimethylolpropane triacrylate, dipentaerythritol pentaacrylate, or polyurethane acrylate.

According to some embodiments of this application, the hardening solution includes a curing agent. According to some embodiments of this application, the curing agent includes a UV curing initiator or a heat curing initiator. According to some embodiments of this application, the UV curing initiator includes at least one of diphenyl(2,4,6-trimethylbenzoyl)phosphine oxide (TPO), 1-hydroxycyclohexyl phenyl ketone or 2-hydroxy-4′-(2-hydroxyethoxy)-2-methylpropiophenone. According to some embodiments of this application, the heat curing initiator includes at least one of benzoyl peroxide, tert-butyl peroxybenzoate, or dicumyl peroxide.

According to some embodiments of this application, the hardening solution includes a solvent, the solvent includes at least one of ethyl acetate, n-butyl alcohol, isopropanol, cyclohexanone, or toluene; a mass percentage of the solvent is 3 to 34%.

According to some embodiments of this application, based on a total mass of the hardening solution, a mass percentage of the polyacrylate prepolymer is 40% to 70%, a mass percentage of the curing agent is 2% to 6%.

According to some embodiments of this application, the hardening solution further includes an acrylate compound having 1 or 2 alkenyl groups. According to some embodiments of this application, based on a total mass of the hardening solution, a mass percentage of the acrylate compound is 0% to 30%.

According to some embodiments of this application, the acrylate compound includes at least one of methyl methacrylate, ethyl methacrylate, 1,6-hexanediol diacrylate, or dipropylene glycol diacrylate.

According to some embodiments of this application, a mass percentage of the polyacrylate prepolymer in the hardening solution is 40% to 70%. In some embodiments of this application, the mass percentage of the polyacrylate prepolymer in the hardening solution is 40%, 45%, 50%, 55%, 60%, 65%, 70%, or any value therebetween.

According to some embodiments of this application, a mass percentage of the curing agent in the hardening solution is 2% to 6%. In some embodiments of this application, the mass percentage of the curing agent in the hardening solution is 2%, 2.5%, 3%, 3.5%, 4%, 4.5%, 5%, 5.5%, 6%, or any value therebetween.

According to some embodiments of this application, a mass percentage of the acrylate compound in the hardening solution is 0% to 30%. In some embodiments of this application, the hardening solution contains no acrylate compound. In some embodiments of this application, the hardening solution contains an acrylate compound. In some embodiments of this application, the mass percentage of the acrylate compound in the hardening solution is 1%, 5%, 10%, 15%, 20%, 25%, 30%, or any value therebetween.

According to some embodiments of this application, a mass percentage of the solvent in the hardening solution is 0% to 34%. In some embodiments of this application, the hardening solution contains no solvent. In some other embodiments of this application, the hardening solution contains a solvent. In some embodiments of this application, the mass percentage of the solvent in the hardening solution is 1%, 5%, 10%, 15%, 20%, 25%, 30%, 34%, or any value therebetween.

According to some embodiments of this application, the substrate includes at least one of polyethylene terephthalate, polypropylene, or polyethylene.

According to some embodiments of this application, the adhesive layer includes at least one of polymethyl methacrylate (PMMA), polyolefin (PO), or rubber.

According to some embodiments of this application, the adhesive layer is located on a surface of the substrate and/or the hardening layer.

According to some embodiments of this application, thickness of the adhesive layer is 1 μm to 30 μm. In some embodiments of this application, the thickness of the adhesive layer is 1 μm, 2 μm, 5 μm, 10 μm, 15 μm, 20 μm, 25 μm, 30 μm, or any value therebetween. According to some embodiments of this application, the thickness of the adhesive layer is 2 μm to 10 μm.

According to some embodiments of this application, the hardening layer is provided on both or either of two opposite surfaces of the substrate.

According to some embodiments of this application, a preparation process of the adhesive tape includes the following steps.

Q1: applying the hardening solution on the surface of the substrate, and curing the hardening solution to form a composite membrane with the hardening layer on a surface thereof; and

Q2: applying the adhesive tape on the surface of the composite membrane, removing the solvent, and performing winding to obtain the adhesive tape.

According to some embodiments of this application, in step Q1, the applying may be roll applying, slight recessing, or other printing manners. According to some embodiments of this application, in step Q1, the curing may be heat curing or UV curing. According to some embodiments of this application, in step Q1, heat curing temperature is 90° C. to 130° C. and heat curing duration is 1 min to 4 min. In some embodiments of this application, in step Q1, the heat curing temperature is 90° C., 100° C., 110° C., 120° C., 130° C., or any value therebetween. In some embodiments of this application, in step Q1, the heat curing duration is 1 min, 1.5 min, 2 min, 2.5 min, 3 min, 3.5 min, 4 min, or any value therebetween. According to some embodiments of this application, in step Q1, energy of the UV curing is 500 mJ/cm² to 700 mJ/cm². In some embodiments of this application, in step Q1, the energy of the UV curing is 500 mJ/cm², 550 mJ/cm², 600 mJ/cm², 650 mJ/cm², 700 mJ/cm², or any value therebetween.

According to some embodiments of this application, in step Q2, the solvent may be removed by heating. According to some embodiments of this application, in step Q2, heating temperature is 90° C. to 130° C. and heating duration is 1 min to 4 min. In some embodiments of this application, in step Q2, the heating temperature is 90° C., 100° C., 110° C., 120° C., 130° C., or any value therebetween. In some embodiments of this application, in step Q2, the heating duration is 1 min, 1.5 min, 2 min, 2.5 min, 3 min, 3.5 min, 4 min, or any value therebetween. According to some embodiments of this application, in step Q2, the composite membrane is coated with the adhesive layer coated on two surfaces with the adhesive layer to obtain a double-sided adhesive tape. According to some other embodiments of this application, in step Q2, the composite membrane is coated on one surface with the adhesive layer to obtain a single-sided adhesive tape. In some embodiments of this application, a surface of the composite membrane away from the hardening layer is coated with the adhesive layer.

According to a second aspect, this application provides an electrochemical apparatus, including an electrode assembly and the adhesive tape according to the first aspect of this application.

According to some embodiments of this application, the electrode assembly includes a positive electrode, a negative electrode, and a separator.

According to some embodiments of this application, the adhesive tape is used as a winding adhesive tape of the electrode assembly in the electrochemical apparatus, a connecting adhesive tape (SIS adhesive tape) of the electrode assembly and an outer packaging bag, a tab protection adhesive tape, a lithium precipitation prevention adhesive tape, or the like.

According to a third aspect, this application further provides an electronic apparatus, including the electrochemical apparatus according to the second aspect of this application.

In the adhesive tape of this application, the composite membrane being provided with the hardening layer on the substrate increases hardness of the composite membrane, so that the adhesive tape has both small thickness and high hardness, thereby allowing volumetric energy density of electrochemical apparatuses to be constantly increased and effectively avoiding wrinkling of the adhesive tape in the electrochemical apparatus.

### BRIEF DESCRIPTION OF DRAWINGS

FIGURE shows a schematic diagram of an adhesive tape according to an embodiment of this application, where 1 represents adhesive layer, 2 represents substrate, and 3 represents hardening layer.

### DETAILED DESCRIPTION

To make the objectives, technical solutions, and advantages of this application clearer, the following clearly and completely describes the technical solutions in this application with reference to the embodiments. Apparently, the described embodiments are some but not all of the embodiments of this application. The embodiments described herein are illustrative and used to provide a basic understanding of this application. The embodiments of this application should not be construed as a limitation on this application.

For brevity, this specification specifically discloses only some numerical ranges. However, any lower limit may be combined with any upper limit to form a range not expressly recorded; any lower limit may be combined with any other lower limit to form a range not expressly recorded; and any upper limit may be combined with any other upper limit to form a range not expressly recorded. In addition, each individually disclosed point or individual single numerical value may itself be a lower limit or an upper limit which can be combined with any other point or individual numerical value or combined with another lower limit or upper limit to form a range not expressly recorded.

In the descriptions of this specification, “more than” or “less than” is inclusive of the present number unless otherwise specified.

Unless otherwise specified, numerical values of parameters mentioned in this application may be measured by using various measurement methods commonly used in the art (for example, they may be tested by using the methods provided in the embodiments of this application).

A list of items connected by the terms “at least one of”, “at least one piece of”, “at least one kind of”, or the like may mean any combination of the listed items. For example, if items A or B are listed, the phrase “at least one of A or B” means only A; only B; or A or B. In another example, if items A, B, or C are listed, the phrase “at least one of A, B, or C” means only A; only B; only C; A or B (exclusive of C); A or C (exclusive of B); B or C (exclusive of A); or all of A, B, or C. The item A may contain one or more constituents. The item B may contain one or more constituents. The item C may contain one or more constituents.

I. Adhesive Tape

An adhesive tape provided in this application includes a composite membrane and an adhesive layer, where the composite membrane includes a substrate and a hardening layer provided on a surface of the substrate, and a hardness of the hardening layer is 3H to 9H. According to some embodiments of this application, the hardness of the hardening layer is 3H, 4H, 5H, 6H, 7H, 8H, or 9H.

According to some embodiments of this application, a thickness of the hardening layer is 0.5 μm to 5 μm. According to some embodiments of this application, the thickness of the hardening layer is 0.5 μm, 1 μm, 2 μm, 2.5 μm, 3 μm, 3.5 μm, 4 μm, 4.5 μm, 5 μm, or any value therebetween.

According to some embodiments of this application, a thickness of the substrate is 2 μm to 8 μm. According to some embodiments of this application, the thickness of the substrate is 2 μm, 3 μm, 4 μm, 5 μm, 6 μm, 7 μm, 8 μm, or any value therebetween.

In the adhesive tape of this application, the composite membrane being provided with the hardening layer on the substrate increases hardness of the composite membrane, so that the adhesive tape has both small thickness and high hardness, thereby allowing volumetric energy density of electrochemical apparatuses to be constantly increased and effectively avoiding wrinkling of the adhesive tape in the electrochemical apparatus.

According to some embodiments of this application, a dissolution rate of the composite membrane in an electrolyte solvent is 0.2% to 6%. According to some embodiments of this application, the dissolution rate of the composite membrane in the electrolyte solvent is 0.2%, 0.5%, 1%, 1.5%, 2%, 2.5%, 3%, 3.5%, 4%, 4.5%, 5%, 5.5%, 6%, or any value therebetween. In this application, the dissolution rate of the composite membrane in the electrolyte solvent is a weight change rate of the composite membrane after being subjected to soaking in the electrolyte solvent, pre-drying, and re-drying, and can be obtained based on a formula: dissolution rate=(weight before soaking−weight after drying)/weight before soaking×100%. Soaking temperature is 80° C. and soaking duration is 6 days. Pre-drying duration is 4 days and pre-drying temperature is 60° C. Re-drying temperature is 115° C. and re-drying duration is 2 days. The electrolyte solvent includes ethylene carbonate (EC), propylene carbonate (PC), diethyl carbonate (DEC), and ethyl propionate (EP). In some specific embodiments, the electrolyte solvent for testing the dissolution rate is ethylene carbonate (EC), propylene carbonate (PC), diethyl carbonate (DEC), and ethyl propionate (EP), where a mass ratio of EC:PC:DEC:EP is equal to 3:1:3:3.

According to some embodiments of this application, the hardening layer is formed by curing a hardening solution.

According to some embodiments of this application, the hardening solution includes a polyacrylate prepolymer, and the polyacrylate prepolymer includes 3 to 9 alkene functional groups. As the number of alkene functional groups increases, a polymerization degree and hardness of the polyacrylate prepolymer are also increased, reducing the dissolution rate in electrolyte of the electrochemical apparatus.

According to some embodiments of this application, the polyacrylate prepolymer further includes one or more of a benzene ring, heterocycle, or bridged-ring functional group.

According to some embodiments of this application, the polyacrylate prepolymer includes at least one of di(trimethylolpropane) tetraacrylate, ethoxylated trimethylolpropane triacrylate, dipentaerythritol pentaacrylate, or polyurethane acrylate.

According to some embodiments of this application, the hardening solution includes a curing agent. According to some embodiments of this application, the curing agent includes a UV curing initiator or a heat curing initiator. According to some embodiments of this application, the UV curing initiator includes at least one of diphenyl(2,4,6-trimethylbenzoyl)phosphine oxide (TPO), 1-hydroxycyclohexyl phenyl ketone or 2-hydroxy-4′-(2-hydroxyethoxy)-2-methylpropiophenone. According to some embodiments of this application, the heat curing initiator includes at least one of benzoyl peroxide, tert-butyl peroxybenzoate, or dicumyl peroxide.

According to some embodiments of this application, the hardening solution includes a solvent, the solvent includes at least one of ethyl acetate, n-butyl alcohol, isopropanol, cyclohexanone, or toluene, a mass percentage of the solvent is 3 to 34%

According to some embodiments of this application, based on a total mass of the hardening solution, a mass percentage of the polyacrylate prepolymer is 40% to 70%, a mass percentage of the curing agent is 2% to 6%.

According to some embodiments of this application, the hardening solution further includes an acrylate compound having 1 or 2 alkenyl groups. According to some embodiments of this application, based on a total mass of the hardening solution, a mass percentage of the acrylate compound is 0% to 30%.

According to some embodiments of this application, the acrylate compound includes at least one of methyl methacrylate, ethyl methacrylate, 1,6-hexanediol diacrylate, or dipropylene glycol diacrylate.

According to some embodiments of this application, a mass percentage of the polyacrylate prepolymer in the hardening solution is 40% to 70%. In some embodiments of this application, the mass percentage of the polyacrylate prepolymer in the hardening solution is 40%, 45%, 50%, 55%, 60%, 65%, 70%, or any value therebetween.

According to some embodiments of this application, a mass percentage of the curing agent in the hardening solution is 2% to 6%. In some embodiments of this application, the mass percentage of the curing agent in the hardening solution is 2%, 2.5%, 3%, 3.5%, 4%, 4.5%, 5%, 5.5%, 6%, or any value therebetween.

According to some embodiments of this application, a mass percentage of the acrylate compound in the hardening solution is 0% to 30%. In some embodiments of this application, the hardening solution contains no acrylate compound. In some embodiments of this application, the hardening solution contains an acrylate compound. In some embodiments of this application, the mass percentage of the acrylate compound in the hardening solution is 1%, 5%, 10%, 15%, 20%, 25%, 30%, or any value therebetween.

According to some embodiments of this application, a mass percentage of the solvent in the hardening solution is 0% to 34%. In some embodiments of this application, the hardening solution contains no solvent. In some other embodiments of this application, the hardening solution contains a solvent. In some embodiments of this application, the mass percentage of the solvent in the hardening solution is 1%, 5%, 10%, 15%, 20%, 25%, 30%, 34%, or any value therebetween.

According to some embodiments of this application, the substrate includes at least one of polyethylene terephthalate, polypropylene, or polyethylene.

According to some embodiments of this application, the adhesive layer includes at least one of polymethyl methacrylate (PMMA), polyolefin (PO), or rubber.

According to some embodiments of this application, the adhesive layer is located on a surface of the substrate and/or the hardening layer.

According to some embodiments of this application, thickness of the adhesive layer is 1 μm to 30 μm. In some embodiments of this application, the thickness of the adhesive layer is 1 μm, 2 μm, 5 μm, 10 μm, 15 μm, 20 μm, 25 μm, 30 μm, or any value therebetween. According to some embodiments of this application, the thickness of the adhesive layer is 2 μm to 10 μm.

According to some embodiments of this application, the hardening layer is provided on both or either of two opposite surfaces of the substrate.

According to some embodiments of this application, a preparation process of the adhesive tape includes the following steps:

Q1: applying the hardening solution on the surface of the substrate, and curing the hardening solution to form a composite membrane with the hardening layer on a surface thereof; and

Q2: applying the adhesive tape on the surface of the composite membrane, removing the solvent, and performing winding to obtain the adhesive tape.

According to some embodiments of this application, in step Q1, the applying may be roll applying, slight recessing, or other printing manners. According to some embodiments of this application, in step Q1, the curing may be heat curing or UV curing. According to some embodiments of this application, in step Q1, heat curing temperature is 90° C. to 130° C. and heat curing duration is 1 min to 4 min. In some embodiments of this application, in step Q1, the heat curing temperature is 90° C., 100° C., 110° C., 120° C., 130° C., or any value therebetween. In some embodiments of this application, in step Q1, the heat curing duration is 1 min, 1.5 min, 2 min, 2.5 min, 3 min, 3.5 min, 4 min, or any value therebetween. According to some embodiments of this application, in step Q1, energy of the UV curing is 500 mJ/cm² to 700 mJ/cm². In some embodiments of this application, in step Q1, the energy of the UV curing is 500 mJ/cm², 550 mJ/cm², 600 mJ/cm², 650 mJ/cm², 700 mJ/cm², or any value therebetween.

According to some embodiments of this application, in step Q2, the solvent may be removed by heating. According to some embodiments of this application, in step Q2, heating temperature is 90° C. to 130° C. and heating duration is 1 min to 4 min. In some embodiments of this application, in step Q2, the heating temperature is 90° C., 100° C., 110° C., 120° C., 130° C., or any value therebetween. In some embodiments of this application, in step Q2, the heating duration is 1 min, 1.5 min, 2 min, 2.5 min, 3 min, 3.5 min, 4 min, or any value therebetween. According to some embodiments of this application, in step Q2, the composite membrane is coated on two surfaces with the adhesive layer to obtain a double-sided adhesive tape. According to some other embodiments of this application, in step Q2, the composite membrane is coated on one surface with the adhesive layer to obtain a single-sided adhesive tape. In some embodiments of this application, a surface of the composite membrane away from the hardening layer is coated with the adhesive layer.

II. Electrochemical Apparatus

An electrochemical apparatus provided in this application includes an electrode assembly and the adhesive tape according to the first aspect of this application.

According to some embodiments of this application, the electrode assembly includes a positive electrode, a negative electrode, and a separator.

According to some embodiments of this application, the adhesive tape is used as a winding adhesive tape of the electrode assembly in the electrochemical apparatus, a connecting adhesive tape (SIS adhesive tape) of the electrode assembly and an outer packaging bag, a tab protection adhesive tape, a lithium precipitation prevention adhesive tape, or the like.

In some embodiments, the electrochemical apparatus according to this application includes any apparatus in which an electrochemical reaction takes place. Specific examples of the apparatus include primary batteries or secondary batteries. Especially, the electrochemical apparatus is a lithium secondary battery, including a lithium metal secondary battery, a lithium-ion secondary battery, a lithium polymer secondary battery, or a lithium-ion polymer secondary battery.

1. Negative Electrode

The material, composition and preparation method of a negative electrode used in the electrochemical apparatus according to this application may include any technology disclosed in the prior art.

According to some embodiments of this application, the negative electrode includes a negative electrode current collector and a negative electrode active material layer disposed on at least one surface of the negative electrode current collector.

According to some embodiments of this application, the negative electrode active material layer includes a negative electrode active material, and the negative electrode active material may include a material reversibly intercalating or deintercalating a lithium ion, lithium metal, a lithium metal alloy, a material capable of doping or de-doping lithium, or a transition metal oxide, such as Si and SiOₓ (0<x<2). The material reversibly intercalating and deintercalating lithium ions may be a carbon material. The carbon material may be any carbon-based negative electrode active substance commonly used in a lithium-ion rechargeable electrochemical apparatus. For example, the carbon material includes crystalline carbon, amorphous carbon, and combinations thereof. The crystalline carbon may be amorphous, plate-shaped, flake-shaped, spherical or fiber-shaped natural graphite or artificial graphite. The amorphous carbon may be soft carbon, hard carbon, a mesophase pitch carbonization product, burnt coke, or the like. Both low crystalline carbon and high crystalline carbon can be used as the carbon material. The low crystalline carbon material may generally include soft carbon and hard carbon. The high crystalline carbon material may generally include natural graphite, crystalline graphite, pyrolytic carbon, a mesophase pitch-based carbon fiber, mesophase carbon microbeads, mesophase pitch, and high-temperature calcined carbon (such as petroleum or coke derived from coal tar pitch).

According to some embodiments of this application, the negative electrode active material layer includes a binder, and the binder may include various binder polymers, for example, difluoroethylene-hexafluoropropylene (PVDF-co-HFP), polyvinylidene fluoride, polyacrylonitrile, polymethyl methacrylate, polyvinyl alcohol, carboxymethyl cellulose, hydroxypropyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyethylene, polypropylene, styrene-butadiene rubber, acrylic styrene-butadiene rubber, epoxy resin, and nylon, but not limited to thereto.

According to some embodiments, the negative electrode active material layer further includes a conductive material to improve electrode conductivity. Any conductive material causing no chemical change can be used as the conductive material. For example, the conductive material includes: a carbon-based material such as natural graphite, artificial graphite, carbon black, acetylene black, Ketjen black, and carbon fiber; a metal-based material such as metal powder or metal fiber including copper, nickel, aluminum, silver; a conductive polymer such as a polyphenylene derivative; or any mixture thereof. The current collector may be copper foil, nickel foil, stainless steel foil, titanium foil, nickel foam, copper foam, a polymer substrate coated with a conductive metal, or a combination thereof.

2. Positive Electrode

The material, composition and preparation method of a positive electrode used in the electrochemical apparatus according to this application may include any technology disclosed in the prior art.

According to some embodiments of this application, the positive electrode includes a positive electrode current collector and a positive electrode active substance layer disposed on at least one surface of the positive electrode current collector.

According to some embodiments of this application, the positive electrode active substance layer includes a positive electrode active substance. In some embodiments, the positive electrode active substance includes, but is not limited to, sulfide, a phosphate compound, and lithium transition metal composite oxide. In some embodiments, the positive electrode active substance includes a compound of lithium transition metal family, and has a structure supporting intercalation and deintercalation of lithium ions.

In some embodiments, the positive electrode includes any composition disclosed in the prior art. In some embodiments, the positive electrode is made by forming, on the current collector, a positive electrode material using a positive electrode active substance layer including powder of the compound of lithium transition metal family and a binder.

In some embodiments, the positive electrode active substance layer is usually made by the following operations: dry mixing the positive electrode active material and the binder (a conductive material, a thickener, or the like as required) to form a sheet, pressing the obtained sheet to the positive electrode current collector, or dissolving or dispersing the materials in a liquid medium to form a slurry. The slurry is applied on the positive electrode current collector and dried. In some embodiments, the positive electrode active substance layer includes any material disclosed in the prior art.

3. Electrolyte

The composition and preparation method of an electrolyte used in the electrochemical apparatus according to this application may include any technology disclosed in the prior art.

In some embodiments, the electrolyte in the electrochemical apparatus according to this application includes a lithium salt and a non-aqueous solvent.

In some embodiments of this application, the lithium salt is one or more selected from a group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, LiPF₆ may be selected as the lithium salt because it can provide high ionic conductivity and improve the cycle performance.

The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An instance of the linear carbonate compound is dimethyl carbonate (DMC), diethyl carbonate (DEC), dipropyl carbonate (DPC), methyl propyl carbonate (MPC), ethylene propyl carbonate (EPC), methyl ethyl carbonate (MEC), or a combination thereof. An instance of the cyclic carbonate compound is ethylene carbonate (EC), propylene carbonate (PC), butylene carbonate (BC), vinyl ethylene carbonate (VEC), and a combination thereof. An instance of the fluorocarbonate compound is fluoroethylene carbonate (FEC), 4,5-difluoro-1,3-dioxolan-2-one, 4,4-difluoro-1,3-dioxolan-2-one, 4,4,5-trifluoro-1,3-dioxolan-2-one, 4,4,5,5-tetrafluoro-1,3-dioxolan one, 4-fluoro-5-methyl-1,3-dioxolan-2-one, 4-fluoro-4-methyl-1,3-dioxolan-2-one, 4,5-difluoro-4-methyl-1,3-dioxolan-2-one, 4,4,5-trifluoro-5-methyl-1,3-dioxolan-2-one, 4-trifluoroMethyl ethylence carbonate, and a combination thereof.

An instance of the carboxylate compound is methyl formate, methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, and a combination thereof.

An instance of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, and a combination thereof.

An instance of the another organic solvent is dimethyl sulfoxide, 1,2-dioxolane, sulfolane, methyl-sulfolane, 1,3-dimethyl-2-imidazolidinone, N-methyl-2-pyrrolidone, methylamide, dimethylformamide, acetonitrile, trimethyl phosphate, triethyl phosphate, trioctyl phosphate, phosphate ester, and a combination thereof

4. Separator

The separator used in the electrochemical apparatus according to this application is not particularly limited to any material or shape, and may be based on any technology disclosed in the prior art. In some embodiments, the separator includes a polymer or an inorganic substance formed by a material stable to the electrolyte of this application.

For example, the separator may include a substrate layer and a surface treatment layer. The substrate layer is a non-woven fabric, a membrane, or a composite membrane having a porous structure, and a material of the substrate layer is selected from at least one of polyethylene, polypropylene, polyethylene terephthalate, or polyimide. Specifically, a polypropylene porous membrane, a polyethylene porous membrane, a polypropylene non-woven fabric, a polyethylene non-woven fabric, or a polypropylene-polyethylene-polypropylene porous composite membrane may be selected.

The surface treatment layer is provided on at least one surface of the substrate layer, and the surface treatment layer may be a polymer layer or an inorganic layer, or may be a layer formed by a mixed polymer and an inorganic substance.

The inorganic substance layer includes inorganic particles and the binder. The inorganic particles are selected from at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, a vinylidene fluoride-hexafluoropropylene copolymer, polyamide, polyacrylonitrile, polyacrylate, polyacrylic acid, polyacrylate, polyvinylpyrrolidone, polyvinyl ether, polymethyl methacrylate, polytetrafluoroethylene, or polyhexafluoropropylene.

The polymer layer includes a polymer, and a material of the polymer is selected from at least one of polyamide, polyacrylonitrile, an acrylate polymer, polyacrylic acid, polyacrylate, polyvinylpyrrolidone, polyvinyl ether, polyvinylidene fluoride, or poly(vinylidene fluoride-hexafluoropropylene).

III. Electronic Apparatus

This application further provides an electronic apparatus, including the electrochemical apparatus in the second aspect of this application.

The electronic device or apparatus in this application is not particularly limited. In some embodiments, the electronic device in this application includes, but is not limited to: a notebook computer, a pen-input computer, a mobile computer, an electronic book player, a portable phone, a portable fax machine, a portable copier, a portable printer, a stereo headset, a video recorder, a liquid crystal television, a portable cleaner, a portable CD player, a mini-disc, a transceiver, an electronic notebook, a calculator, a memory card, a portable recorder, a radio, a standby power supply, a motor, an automobile, a motorcycle, an assisted bicycle, a bicycle, a lighting appliance, a toy, a game console, a clock, an electric tool, a flashlight, a camera, a large household battery, or the like.

The following further describes this application with reference to examples. It should be understood that these examples are merely used to describe this application but not to limit the scope of this application.

Test Method

1. Thickness Test

Test method: thicknesses of five different portions of a sample were measured by using a micrometer, and an average of the thicknesses was used as the thickness of the sample.

2. Hardness Test

Test method: a hardening layer was subjected to a pencil hardness test according to JISK5400-1990 Testing Method for Paints.

3. Test of Dissolution Rate

Test method: an adhesive tape was detached from a battery cell; an adhesive layer was wiped thoroughly by using dust-free paper dipped with toluene or ethyl acetate (infrared spectroscopy showed that a surface of the substrate had no characteristic peak of the adhesive layer, and a peeling force at 180° was ON) to obtain a composite membrane; and the composite membrane (weight a) was placed into a mixed solvent (ethylene carbonate:propylene carbonate:diethyl carbonate:ethyl propionate (EC/PC/DEC/EP)=3:1:3:3, where the weight of the mixed solvent was 50 to 60 times the weight of the composite membrane), soaked for 6 days at 80° C., placed in an oven for 4 days at 60° C., pre-dried and extracted, and placed in the oven again for drying for 2 days at 115° C., and then the dried composite membrane was weighed (weight b), where the dissolution rate was equal to (1−b/a)*100%.

4. Tape Wrinkling Rate

Test method: after an existing adhesive tape sticking machine performed sticking, if wrinkles were manually detected at a tape sticking location of a battery cell (a bulge can be sensed with a hand), the battery cell was determined as a damaged product with the wrinkles. Damaged battery cells were counted in a production cycle (batch), and the number of the damaged battery cells was not less than 1000.

Polymer Used

Acrylate was purchased from ALLNEX company, with a product number of EBECRYL 8602.

### Examples and Comparative Examples

1. Preparation of Adhesive Tape

a. Preparation of hardening solution: a polyacrylate prepolymer, an acrylate compound, and a curing agent were dissolved in a solvent through stirring at room temperature, filtered with a 0.5 μm to 1 μm filter element to obtain the hardening solution. Compositions of specific hardening solutions in all examples and comparative examples are shown in Table 1 to Table 4.

b. The hardening solution was applied on a surface of a substrate through roll applying, slight recessing, or other printing manners, heated for 1 min to 4 min at 90° C. to 130° C. or cured with UV hardening energy of 500 mJ/cm² to 700 mJ/cm², and wound to form a composite membrane.

c. An adhesive on an adhesive layer was applied on a surface of the composite membrane, where the adhesive layer and the hardening layer were respectively located on two sides of the substrate, heated for 1 min to 4 min at 90° C. to 130° C. to remove the solvent, and wound to obtain the adhesive tape.

2. Preparation of Positive Electrode Plate

Lithium cobaltate, acetylene black, and polyvinylidene fluoride (PVDF) as positive electrode active materials were mixed in a mass ratio of 94:3:3, N-methylpyrrolidone (NMP) was added as a solvent, to prepare a slurry with a solid percentage of 75%, and the slurry was stirred uniformly. The slurry was uniformly applied on a positive electrode current collector aluminum foil. After drying at 90° C. and cold pressing, a positive electrode plate with a 100 μm thick positive electrode active material layer was obtained. Then the foregoing steps were repeatedly performed on another surface of the positive electrode plate to obtain the positive electrode plate with two surfaces coated with the positive electrode active material layer. The positive electrode plate was cut as per a size of 74 mm×867 mm and then welded with tabs for later use.

3. Preparation of Negative Electrode Plate

Artificial graphite, acetylene black, styrene-butadiene rubber, and sodium carboxy methyl cellulose as negative electrode active materials were mixed in a mass ratio of 96:1:1.5:1.5, then deionized water was added as a solvent, to prepare a slurry with a solid percentage of 70%, and the slurry was stirred uniformly. The slurry was uniformly applied on a current collector. After drying at 110° C. and cold pressing, a negative electrode plate with one surface coated with a 150 μm thick negative electrode active material layer was obtained. Then the foregoing steps were repeatedly performed on another surface of the negative electrode plate to obtain the negative electrode plate with two surfaces coated with the negative electrode active material layer. The negative electrode plate was cut as per a size of 74 mm×867 mm and then welded with tabs for later use.

4. Preparation of Separator: 7 μm PE Separator

5. Preparation of Electrolyte

In an environment with a water content less than 10 ppm, non-aqueous organic solvents of ethylene carbonate (EC), diethyl carbonate (DEC), propylene carbonate (PC), propyl propionate (PP), and vinylene carbonate (VC) were mixed in a mass ratio of 20:30:20:28:2, and then lithium hexafluorophosphate (LiPF₆) was added to the non-aqueous organic solvents, dissolved and mixed uniformly to obtain an electrolyte. A mass ratio of LiPF₆ to the non-aqueous organic solvent was 8:92.

6. Preparation of Lithium-Ion Battery

The prepared positive electrode plate, separator, and negative electrode plate were stacked in sequence, so that the separator was sandwiched between the positive electrode plate and the negative electrode plate for separation. Then the resulting stack was wound to obtain an electrode assembly. The prepared adhesive tape was pasted to the electrode assembly and used as a winding adhesive tape or an ending adhesive tape. The electrode assembly was put into an aluminum-plastic film packaging bag, and was dehydrated at 80° C., and the prepared electrolyte was injected. Then, after processes including vacuum packaging, standing, formation, and shaping, the lithium-ion battery was obtained.

From the adhesive tapes in Comparative Example 1 and Comparative Example 2 as given in Table 1, it can be seen that after the substrate of the adhesive tape was thinned, the wrinkling rate of the adhesive tape without the hardening layer was greatly increased. Example 1 to Example 4 showed influence of the hardness of the hardening layer and the dissolution rate of the composite membrane on the prepared adhesive tape and the lithium-ion battery including the adhesive tape. It can be seen from Example 1 to Example 4 in Table 1 that the adhesive tape being provided with the hardening layer reduces the thickness of the substrate and greatly reduces the tape wrinkling rate, thereby improving the manufacturing process efficiency of the lithium-ion battery.

TABLE 1

| | Composite membrane | | | | | | |
|---|---|---|---|---|---|---|---|
| | Formula of hardening solution | | | | Hardening layer | | Substrate |
| | Acrylate | Polyacrylate | Curing | | Thickness | | Thickness |
| Example | compound | prepolymer | agent | Solvent | (μm) | Hardness | (μm) |
| Comparative | 0 | 0 | 0 | 0 | 0 | 0 | 12 |
| Example 1 | | | | | | | |
| Comparative | 0 | 0 | 0 | 0 | 0 | 0 | 2 |
| Example 2 | | | | | | | |
| 1 | Methyl | Di(trimethylolpropane) | Benzoyl | Ethyl | 3 | 4H | 2 |
| | methacrylate | tetraacrylate 70% | peroxide | acetate | | | |
| | 10% | | 3% | 17% | | | |
| 2 | Methyl | EBECRYL | Benzoyl | Ethyl | 3 | 9H | 2 |
| | methacrylate | 8602 40% | peroxide | acetate | | | |
| | 20% | | 6% | 34% | | | |
| 3 | Methyl | Dipentaerythritol | Benzoyl | Ethyl | 3 | 5H | 2 |
| | methacrylate | pentaacrylate 40% | peroxide | acetate | | | |
| | 20% | | 6% | 34% | | | |
| 4 | Methyl | Ethoxylated | Photoinitiat184 | 0% | 3 | 3H | 2 |
| | methacrylate | trimethylolpropane | 4% | | | | |
| | 30% | triacrylate 66% | | | | | |

| | | | | | Effect | | |
|---|---|---|---|---|---|---|---|
| | | | | | (Total thickness of | | |
| | | | | | adhesive tape in | | |
| | | | | | comparison with thickness | | |
| | Composite membrane | | | | of adhesive tape in | | |
| | | Dissolution | | | Comparative Example 1) | | |
| | | rate of | | | Tape | Used as | Used as |
| | | composite | Adhesive layer | | wrinkling | ending | winding |
| | Substrate | membrane | Thickness | | rate | adhesive | adhesive |
| Example | Material | (%) | (μm) | Material | (%) | tape | tape |
| Comparative | PET | 0 | 6 | Polyolefin | 0.04 | Reference | Reference |
| Example 1 | | | | | | value | value |
| Comparative | PET | 0 | 6 | Polyolefin | 95.1 | Thinned | Thinned |
| Example 2 | | | | | | by 7 μm | by 14 μm |
| 1 | PET | 4.3 | 6 | Polyolefin | 0.05 | Thinned | Thinned |
| | | | | | | by 7 μm | by 14 μm |
| 2 | PET | 0.2 | 6 | Polyolefin | 0.01 | Thinned | Thinned |
| | | | | | | by 7 μm | by 14 μm |
| 3 | PET | 3.2 | 6 | Polyolefin | 0.02 | Thinned | Thinned |
| | | | | | | by 7 μm | by 14 μm |
| 4 | PET | 6.0 | 6 | Polyolefin | 0.05 | Thinned | Thinned |
| | | | | | | by 7 μm | by 14 μm |

Example 5 to Example 11 in Table 2 show influence of the composition of the hardening solution on the prepared adhesive tape and the lithium-ion battery including the adhesive tape. It can be seen from Example 5 to Example 11 in Table 2 that when the formed hardening layers have same hardness, the formula of the hardening solution changes within a suitable range, which has small influence on the tape wrinkling rate.

TABLE 2

| | Composite membrane | | | | | | |
|---|---|---|---|---|---|---|---|
| | Formula of hardening solution | | | | Hardening layer | | Substrate |
| | Acrylate | Polyacrylate | Curing | | Thickness | | Thickness |
| Example | compound | prepolymer | agent | Solvent | (μm) | Hardness | (μm) |
| 5 | 0% | Di(trimethylolpropane) | Benzoyl | Ethyl | 3 | 4H | 2 |
| | | tetraacrylate | peroxide | acetate | | | |
| | | 70% | 2% | 28% | | | |
| 6 | Methyl | Di(trimethylolpropane) | Benzoyl | Ethyl | 3 | 4H | 2 |
| | methacrylate | tetraacrylate | peroxide | acetate | | | |
| | 30% | 40% | 6% | 24% | | | |
| 7 | Methyl | Di(trimethylolpropane) | Benzoyl | Ethyl | 3 | 4H | 2 |
| | methacrylate | tetraacrylate | peroxide | acetate | | | |
| | 4% | 56% | 6% | 24% | | | |
| 8 | Methyl | Di(trimethylolpropane) | Benzoyl | Ethyl | 3 | 4H | 2 |
| | methacrylate | tetraacrylate | peroxide | acetate | | | |
| | 14% | 56% | 2% | 28% | | | |
| 9 | Methyl | Di(trimethylolpropane) | Benzoyl | Ethyl | 3 | 4H | 2 |
| | methacrylate | tetraacrylate | peroxide | acetate | | | |
| | 14% | 56% | 4% | 26% | | | |
| 10 | Methyl | Di(trimethylolpropane) | Benzoyl | Ethyl | 3 | 3H | 2 |
| | methacrylate | tetraacrylate | peroxide | acetate | | | |
| | 6% | 56% | 4% | 34% | | | |
| 11 | Methyl | Ethoxylated | Photoinitiator | 0% | 3 | 3H | 2 |
| | methacrylate | trimethylolpropane | 184 4% | | | | |
| | 30% | triacrylate | | | | | |
| | | 66% | | | | | |

| | | | | | Effect | | |
|---|---|---|---|---|---|---|---|
| | | | | | (Total thickness of | | |
| | | | | | adhesive tape in | | |
| | | | | | comparison with thickness | | |
| | Composite membrane | | | | of adhesive tape in | | |
| | | Dissolution | | | Comparative Example 1) | | |
| | | rate of | | | Tape | Used as | Used as |
| | | composite | Adhesive layer | | wrinkling | ending | winding |
| | Substrate | membrane | Thickness | | rate | adhesive | adhesive |
| Example | Material | (%) | (μm) | Material | (%) | tape | tape |
| 5 | PET | 4.6 | 6 | Polyolefin | 0.05 | Thinned | Thinned |
| | | | | | | by 7 μm | by 14 μm |
| 6 | PET | 4.9 | 6 | Polyolefin | 0.05 | Thinned | Thinned |
| | | | | | | by 7 μm | by 14 μm |
| 7 | PET | 4.5 | 6 | Polyolefin | 0.05 | Thinned | Thinned |
| | | | | | | by 7 μm | by 14 μm |
| 8 | PET | 4.5 | 2 | Polyolefin | 0.05 | Thinned | Thinned |
| | | | | | | by 11 μm | by 22 μm |
| 9 | PET | 4.5 | 2 | Polyolefin | 0.05 | Thinned | Thinned |
| | | | | | | by 11 μm | by 22 μm |
| 10 | PET | 4.5 | 2 | Polyolefin | 0.05 | Thinned | Thinned |
| | | | | | | by 11 μm | by 22 μm |
| 11 | PET | 6.0 | 2 | Polyolefin | 0.05 | Thinned | Thinned |
| | | | | | | by 11 μm | by 22 μm |

Example 12 to Example 14 in Table 3 show influence of the thickness of the substrate on the prepared adhesive tape and the lithium-ion battery including the adhesive tape. It can be seen from Example to Example 14 in Table 3 that a thicker substrate means a lower tape wrinkling rate. However, when the substrate is excessively thick, a loss of energy density of batteries is likely to be caused.

TABLE 3

| | Composite membrane | | | | | | |
|---|---|---|---|---|---|---|---|
| | Formula of hardening solution | | | | Hardening layer | | Substrate |
| | Acrylate | Polyacrylate | Curing | | Thickness | | Thickness |
| Example | compound | prepolymer | agent | Solvent | (μm) | Hardness | (μm) |
| 12 | Methyl | Dipentaerythritol | Benzoyl | Ethyl | 3 | 5H | 4 |
| | methacrylate | pentaacrylate 40% | peroxide | acetate | | | |
| | 20% | | 6% | 34% | | | |
| 13 | Methyl | Dipentaerythritol | Benzoyl | Ethyl | 3 | 5H | 8 |
| | methacrylate | pentaacrylate 40% | peroxide | acetate | | | |
| | 20% | | 6% | 34% | | | |
| 14 | Methyl | Dipentaerythritol | Benzoyl | Ethyl | 3 | 5H | 6 |
| | methacrylate | pentaacrylate 40% | peroxide | acetate | | | |
| | 20% | | 6% | 34% | | | |

| | | | | | Effect | | |
|---|---|---|---|---|---|---|---|
| | | | | | (Total thickness of | | |
| | | | | | adhesive tape in | | |
| | | | | | comparison with thickness | | |
| | Composite membrane | | | | of adhesive tape in | | |
| | | Dissolution | | | Comparative Example 1) | | |
| | | rate of | | | Tape | Used as | Used as |
| | | composite | Adhesive layer | | wrinkling | ending | winding |
| | Substrate | membrane | Thickness | | rate | adhesive | adhesive |
| Example | Material | (%) | (μm) | Material | (%) | tape | tape |
| 12 | PET | 3.2 | 6 | Polyolefin | 0.02 | Thinned | Thinned |
| | | | | | | by 5 μm | by 10 μm |
| 13 | PET | 3.2 | 6 | Polyolefin | 0.00 | Thinned | Thinned |
| | | | | | | by 1 μm | by 2 μm |
| 14 | PET | 3.2 | 6 | Polyolefin | 0.02% | Thinned | Thinned |
| | | | | | | by 3 μm | by 6 μm |

Example 15 to Example 17 in Table 4 show influence of the thickness of the hardening layer on the prepared adhesive tape and the lithium-ion battery containing the adhesive tape. It can be seen from a comparison of Example 15 to Example 17 in Table 4 that a thinner hardening layer means a lower dissolution rate of the composite membrane, that is, the thickness of the hardening layer is set within an approximate range.

TABLE 4

| | Composite membrane | | | | | | |
|---|---|---|---|---|---|---|---|
| | Formula of hardening solution | | | | Hardening layer | | Substrate |
| | Acrylate | Polyacrylate | Curing | | Thickness | | Thickness |
| Example | compound | prepolymer | agent | Solvent | (μm) | Hardness | (μm) |
| 15 | Methyl | Dipentaerythritol | Benzoyl | Ethyl | 3 | 5H | 2 |
| | methacrylate | pentaacrylate 40% | peroxide | acetate | | | |
| | 20% | | 6% | 34% | | | |
| 16 | Methyl | Dipentaerythritol | Benzoyl | Ethyl | 0.5 | 9H | 2 |
| | methacrylate | pentaacrylate 40% | peroxide | acetate | | | |
| | 20% | | 6% | 34% | | | |
| 17 | Methyl | Dipentaerythritol | Benzoyl | Ethyl | 5 | 5H | 2 |
| | methacrylate | pentaacrylate 40% | peroxide | acetate | | | |
| | 20% | | 6% | 34% | | | |

| | | | | | Effect | | |
|---|---|---|---|---|---|---|---|
| | | | | | (Total thickness of | | |
| | | | | | adhesive tape in | | |
| | | | | | comparison with thickness | | |
| | Composite membrane | | | | of adhesive tape in | | |
| | | Dissolution | | | Comparative Example 1) | | |
| | | rate of | | | Tape | Used as | Used as |
| | | composite | Adhesive layer | | wrinkling | ending | winding |
| | Substrate | membrane | Thickness | | rate | adhesive | adhesive |
| Example | Material | (%) | (μm) | Material | (%) | tape | tape |
| 15 | PET | 3.2 | 6 | Polyolefin | 0.02 | Thinned | Thinned |
| | | | | | | by 7 μm | by 14 μm |
| 16 | PET | 0.2 | 6 | Polyolefin | 0.02 | Thinned | Thinned |
| | | | | | | by 9.5 μm | by 19 μm |
| 17 | PET | 4.6 | 6 | Polyolefin | 0.02 | Thinned | Thinned |
| | | | | | | by 5 μm | by 10 μm |

Although illustrative embodiments have been demonstrated and described, a person skilled in the art should understand that the foregoing embodiments are not to be construed as limiting this application, and that the embodiments may be changed, replaced, and modified without departing from the spirit, principle, and scope of this application.

What is claimed is:

1. An adhesive tape, comprising a composite membrane and an adhesive layer, wherein the composite membrane comprises a substrate and a hardening layer provided on at least one surface of the substrate, and a hardness of the hardening layer is 3H to 9H.

2. The adhesive tape according to claim 1, the hardness of the hardening layer is 5H to 9H.

3. The adhesive tape according to claim 1, wherein a thickness of the substrate is 2 μm to 8 μm.

4. The adhesive tape according to claim 1, wherein a thickness of the hardening layer is 0.5 μm to 5 μm.

5. The adhesive tape according to claim 1, wherein a dissolution rate of the composite membrane in an electrolyte solvent is 0.2% to 6%.

6. The adhesive tape according to claim 1, wherein the hardening layer is formed by curing a hardening solution.

7. The adhesive tape according to claim 6, wherein the hardening solution comprises a polyacrylate prepolymer, and the polyacrylate prepolymer comprises 3 to 9 alkene functional groups.

8. The adhesive tape according to claim 7, wherein the polyacrylate prepolymer further comprises one or more of a benzene ring, heterocycle, or bridged-ring functional group.

9. The adhesive tape according to claim 7, wherein the hardening solution further comprises a curing agent, and based on a total mass of the hardening solution, a mass percentage of the polyacrylate prepolymer is 40% to 70%, a mass percentage of the curing agent is 2% to 6%.

10. The adhesive tape according to claim 9, wherein the hardening solution further comprises a solvent, and a mass percentage of the solvent is 3 to 34%.

11. The adhesive tape according to claim 9, wherein the polyacrylate prepolymer comprises at least one of di(trimethylolpropane) tetraacrylate, ethoxylated trimethylolpropane triacrylate, dipentaerythritol pentaacrylate, or polyurethane acrylate;
the curing agent comprises a UV curing initiator or a heat curing initiator, wherein the UV curing initiator comprises at least one of diphenyl(2,4,6-trimethylbenzoyl)phosphine oxide, 1-hydroxycyclohexyl phenyl ketone or 2-hydroxy-4′-(2-hydroxyethoxy)-2-methylpropiophenone; and the heat curing initiator comprises at least one of benzoyl peroxide, tert-butyl peroxybenzoate, or dicumyl peroxide; and
the solvent comprises at least one of ethyl acetate, n-butyl alcohol, isopropanol, cyclohexanone, or toluene.

12. The adhesive tape according to claim 7, wherein the hardening solution further comprises an acrylate compound having 1 or 2 alkenyl groups; and based on a total mass of the hardening solution, a mass percentage of the acrylate compound is 0% to 30%.

13. The adhesive tape according to claim 12, wherein the acrylate compound comprises at least one of methyl methacrylate, ethyl methacrylate, 1,6-hexanediol diacrylate, or dipropylene glycol diacrylate.

14. The adhesive tape according to claim 1, wherein at least one of the following conditions (a) to (d) is satisfied:
(a) the substrate comprising at least one of polyethylene terephthalate, polypropylene, or polyethylene;
(b) the adhesive layer being located on a surface of the substrate and/or the hardening layer;
(c) the adhesive layer comprising at least one of polymethyl methacrylate, polyolefin, or rubber; and
(d) a thickness of the adhesive layer being 1 μm to 30 μm.

15. An electrochemical apparatus, comprising an electrode assembly and the adhesive tape, the adhesive tape comprises a composite membrane and an adhesive layer, wherein the composite membrane comprises a substrate and a hardening layer provided on at least one surface of the substrate, and a hardness of the hardening layer is 3H to 9H.

16. The electrochemical apparatus according to claim 15, the hardness of the hardening layer is 5H to 9H.

17. The electrochemical apparatus according to claim 15, wherein a thickness of the substrate is 2 μm to 8 μm.

18. The electrochemical apparatus according to claim 15, wherein a thickness of the hardening layer is 0.5 μm to 5 μm.

19. The electrochemical apparatus according to claim 15, wherein a dissolution rate of the composite membrane in an electrolyte solvent is 0.2% to 6%.

20. An electronic apparatus, comprising the electrochemical apparatus according to claim 15.
